(19) United States
(12) Patent Application Publication
(10) Pub. No.: US 2018/0172551 A1
(43) Pub. Date: Jun. 21, 2018

(54) SYSTEMS, METHODS, AND DEVICES FOR AN IMPACT TEST PLATFORM

(71) Applicant: Brainguard Technologies, Inc., El Cerrito, CA (US)

(72) Inventor: Anantha Pradeep, Piedmont, CA (US)

(73) Assignee: Brainguard Technologies, Inc., El Cerrito, CA (US)

(21) Appl. No.: 15/675,640

(22) Filed: Aug. 11, 2017

Related U.S. Application Data
(63) Continuation of application No. 15/387,396, filed on Dec. 21, 2016.

(51) Int. Cl. G01M 7/08; G01N 3/30

(52) U.S. Cl. CPC G01M 7/08; G01N 2203/0085; G01N 2203/0039; G01N 2203/001; G01N 3/30

(57) ABSTRACT

Disclosed herein are systems, methods, and devices for implementing protective gear testing platforms. Systems may include a support structure and a pendulum coupled to the support structure via a first coupling. The pendulum may be configured to be positioned at a first position, and further configured to swing along a pathway in a first direction when released from the first position. Systems may also include a first headform coupled with the pendulum, where the first headform is configured to measure a plurality of forces associated with an impact on the first headform. The systems may also include a base stage configured to be coupled with a target, and further configured to position the target within the pathway.

### CROSS-REFERENCE TO RELATED APPLICATIONS

This application claims benefit under 35 U.S.C. § 120 to U.S. application Ser. No. 15/387,396, entitled SYSTEMS, METHODS, AND DEVICES FOR AN IMPACT TEST PLATFORM, filed Dec. 21, 2016 (Attorney Docket No. BRGDP011), all of which is incorporated herein by reference for all purposes.

### TECHNICAL FIELD

This disclosure generally relates to protective gear and, more specifically, to test platforms associated with protective gear.

### BACKGROUND

Protective gear such as sports and safety helmets are designed to reduce direct impact forces that can mechanically damage an area of contact. Protective gear will typically include padding and a protective shell to reduce the risk of physical head injury. Liners are provided beneath a hardened exterior shell to reduce violent deceleration of the head in a smooth uniform manner and in an extremely short distance, as liner thickness is typically limited based on helmet size considerations.

Protective gear is reasonably effective in preventing injury. Nonetheless, the effectiveness of protective gear remains limited. Moreover, effectiveness of testing such protective gear remains limited.

### BRIEF DESCRIPTION OF THE DRAWINGS

FIG. 1 illustrates an example of a protective gear testing platform, configured in accordance with some embodiments.

FIG. 2 illustrates another view of an example of a protective gear testing platform, configured in accordance with some embodiments.

FIG. 3 illustrates yet another view of an example of a protective gear testing platform, configured in accordance with some embodiments.

FIG. 4 illustrates a base stage associated with a protective gear testing platform, configured in accordance with some embodiments.

FIG. 5 illustrates another view of a base stage associated with a protective gear testing platform, configured in accordance with some embodiments.

FIG. 6 illustrates yet another view of a base stage associated with a protective gear testing platform, configured in accordance with some embodiments.

FIG. 7 illustrates a flow chart of an example of an impact testing method, implemented in accordance with some embodiments.

FIG. 8 illustrates a flow chart of another example of an impact testing method, implemented in accordance with some embodiments.

FIG. 9 illustrates a data processing system configured in accordance with some embodiments.

### DETAILED DESCRIPTION

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques of the present invention will be described in the context of helmets. However, it should be noted that the techniques of the present invention apply to a wide variety of different pieces of protective gear and impact test platforms. In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a protective device may use a single strap in a variety of contexts. However, it will be appreciated that a system can use multiple straps while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, different layers may be connected using a variety of materials. Consequently, a connection does not necessarily mean a direct, unimpeded connection unless otherwise noted.

### Overview

Various embodiments disclosed herein provide the ability to test and assess the efficacy of such protective gear to protect against impact and penetrative forces, as well as rotational and shear forces. Accordingly, as will be discussed in greater detail below, testing systems and devices, also referred to herein as test platforms, may be implemented that include a headform mounted on a pendulum. The pendulum and headform may include various sensors coupled to sensing circuitry that monitor and measure forces experienced by the headform. Accordingly, the headform, while mounted on the pendulum, may be swung at a target, which may be another headform or other object or surface. In various embodiments, a helmet may be mounted on the headform, and measurements may be taken as the headform swings into and impacts the target. As will be discussed in greater detail below, such measurements may be used to assess the efficacy of the helmet to protect against the above-described forces. Moreover, mounting plates may be implemented such that the positions of the headform and the target are adjustable, and can simulate various different directions and types of impact.

As will also be discussed in greater detail below, embodiments as disclosed herein enable the configurability of both the headform mounted on the pendulum as well as the target, thus enabling the simulation of specific impact scenarios, such as a football helmet on turf, or a bicycle helmet on asphalt. Furthermore, configurability of the position and orientation of both the headform mounted on the pendulum as well as the position and orientation of the target may enable the testing of specific impact angles within each scenario, thus enabling the testing of variations of such angles on particular types of head trauma, such as shear injuries, rotational, and impact forces, as well as other factors such as oscillations on the helmet and headform. As will be discussed in greater detail below, the mounting of the headform on the pendulum that is swung towards the target further facilitates the simulation and configurability of these impact scenarios, and facilitates the accurate simulation of a head in motion impacting a target surface or other headform.

### Example Embodiments

Protective gear such as knee pads, shoulder pads, and helmets are typically designed to prevent direct impact injuries or trauma. For example, many pieces of protective gear reduce full impact forces that can structurally damage an area of contact such as the skull or knee. Major emphasis is placed on reducing the likelihood of cracking or breaking of bone. However, the larger issue is preventing the tissue and neurological damage caused by rotational forces, shear forces, oscillations, and tension/compression forces.

For head injuries, the major issue is neurological damage caused by oscillations of the brain in the cranial vault resulting in coup-contracoup injuries manifested as direct contusions to the central nervous system (CNS), shear injuries exacerbated by rotational, tension, compression, and/or shear forces resulting in demyelination and tearing of axonal fibers; and subdural or epidural hematomas. Because of the emphasis in reducing the likelihood of cracking or breaking bone, many pieces of protective gear do not sufficiently dampen, transform, dissipate, and/or distribute the rotational, tension, compression, and/or shear forces, but rather focus on absorbing the direct impact forces over a small area, potentially exacerbating the secondary forces on the CNS. Initial mechanical damage results in a secondary cascade of tissue and cellular damage due to increased glutamate release or other trauma induced molecular cascades.

Traumatic brain injury (TBI) has immense personal, societal and economic impact. The Center for Disease Control and Prevention documented 1.4 million cases of TBI in the USA in 2007. This number was based on patients with a loss of consciousness from a TBI resulting in an Emergency Room visit. With increasing public awareness of TBI this number increased to 1.7 million cases in 2010. Of these cases there were 52,000 deaths and 275,000 hospitalizations, with the remaining 1.35 million cases released from the ER. Of these 1.35 million discharged cases at least 150,000 people will have significant residual cognitive and behavioral problems at 1-year post discharge from the ER. Notably, the CDC believes these numbers under represent the problem since many patients do not seek medical evaluation for brief loss of consciousness due to a TBI. These USA numbers are similar to those observed in other developed countries and are likely higher in third-world countries with poorer vehicle and head impact protection. To put the problem in a clearer perspective, the World Health Organization (WHO) anticipates that TBI will become a leading cause of death and disability in the world by the year 2020.

The CDC numbers do not include head injuries from military actions. Traumatic brain injury is widely cited as the “signature injury” of Operation Enduring Freedom and Operation Iraqi Freedom. The nature of warfare conducted in Iraq and Afghanistan is different from that of previous wars and advances in protective gear including helmets as well as improved medical response times allow soldiers to survive events such as head wounds and blast exposures that previously would have proven fatal. The introduction of the Kevlar helmet has drastically reduced field deaths from bullet and shrapnel wounds to the head. However, this increase in survival is paralleled by a dramatic increase in residual brain injury from compression and rotational forces to the brain in TBI survivors. Similar to that observed in the civilian population the residual effects of military deployment related TBI are neurobehavioral symptoms such as cognitive deficits and emotional and somatic complaints. The statistics provided by the military cite an incidence of 6.2% of head injuries in combat zone veterans. One might expect these numbers to hold in other countries.

In addition to the incidence of TBI in civilians from falls and vehicular accidents or military personnel in combat there is increasing awareness that sports-related repetitive forces applied to the head with or without true loss of consciousness can have dire long-term consequences. It has been known since the 1920's that boxing is associated with devastating long-term issues including “dementia pugilistica” and Parkinson-like symptoms (i.e. Mohammed Ali). We now know that this repetitive force on the brain dysfunction extends to many other sports. Football leads the way in concussions with loss of consciousness and post-traumatic memory loss (63% of all concussions in all sports), wrestling comes in second at 10% and soccer has risen to 6% of all sports related TBIs. In the USA 63,000 high school students suffer a TBI per year and many of these students have persistent long-term cognitive and behavioral issues. This disturbing pattern extends to professional sports where impact forces to the body and head are even higher due to the progressive increase in weight and speed of professional athletes. Football has dominated the national discourse in the area but serious and progressive long-term neurological issues are also seen in hockey and soccer players and in any sport with the likelihood of a TBI. Repetitive head injuries result in progressive neurological deterioration with neuropathological findings mimicking Alzheimer's disease. This syndrome with characteristic post-mortem neuropathological findings on increases in Tau proteins and amyloid plaques is referred to as Chronic Traumatic Encephalopathy (CTE).

The human brain is a relatively delicate organ weighing about 3 pounds and having a consistency a little denser than gelatin and close to that of the liver. From an evolutionary perspective, the brain and the protective skull were not designed to withstand significant external forces. Because of this poor impact resistance design, external forces transmitted through the skull to the brain that is composed of over 100 billion cells and up to a trillion connecting fibers results in major neurological problems. These injuries include contusions that directly destroy brain cells and tear the critical connecting fibers necessary to transmit information between brain cells.

Contusion injuries are simply bleeding into the substance of the brain due to direct contact between the brain and the bony ridges of the inside of the skull. Unfortunately, the brain cannot tolerate blood products and the presence of blood kicks off a biological cascade that further damages the brain. Contusions are due to the brain oscillating inside the skull when an external force is applied. These oscillations can include up to three cycles back and forth in the cranial vault and are referred to as coup-contra coup injuries. The coup part of the process is the point of contact of the brain with the skull and the contra-coup is the next point of contact when the brain oscillates and strikes the opposite part of the inside of the skull.

The inside of the skull has a series of sharp bony ridges in the front of the skull and when the brain is banged against these ridges it is mechanically torn resulting in a contusion. These contusion injuries are typically in the front of the brain damaging key regions involved in cognitive and emotional control.

Shear injuries involve tearing of axonal fibers. The brain and its axonal fibers are extremely sensitive to rotational forces. Boxers can withstand hundreds of punches directly in the face but a single round-house punch or upper cut where the force comes in from the side or bottom of the jaw will cause acute rotation of the skull and brain and typically a knock-out. If the rotational forces are severe enough, the result is tearing of axons.

As discussed above, and will be discussed in greater detail below, protective devices and gear may be implemented to reduce and prevent the above-described injuries. Moreover, various systems, devices, and methods may be implemented to test the efficacy of such protective devices. In this way, the efficacy of such protective devices may be analyzed and compared in various different types of impacts with various different types of objects and/or surfaces.

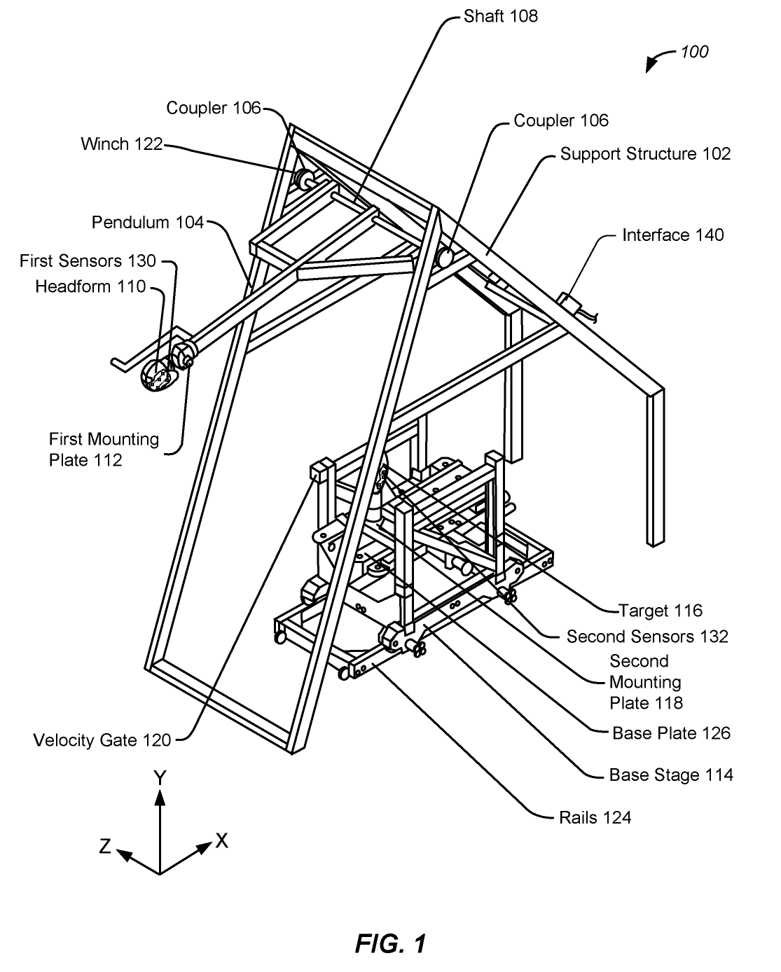

FIG. 1 illustrates an example of a protective gear testing platform, configured in accordance with some embodiments. As will be discussed in greater detail below, a headform may be configured to be mounted to protective gear and devices, such as helmets under test, and may be further configured to be swung along a pathway to impact a particular target. Various sensors may be included in the headform as well as the target, and such sensors may record various forces generated by the impact. As will also be discussed in greater detail below, such measurements may be used to assess an efficacy of the protective gear when protecting against forces generated by impacts.

In various embodiments, protective gear testing platform 100 includes support structure 102. As will be discussed in greater detail below, support structure 102 may be configured to provide structural support for various other components of protective gear testing platform 100, and may facilitate the positioning and release of such components, such as pendulum 104. Accordingly, support structure 102 may be a rigid structure which may be made of a material such as metal, wood, or a polymer. Moreover, support structure 102 may include a coupling mechanism, such as coupler 106, which may be configured to provide mechanical coupling between support structure 102 and pendulum 104. More specifically, coupler 106 may be a rotatable joint that may be coupled to pendulum 104 via another structural member, such as shaft 108. In this way, pendulum 104 may be coupled to support structure 102, and may swing and rotate around an axis concentric or defined by shaft 108. As will be discussed in greater detail below, pendulum 104 may be set in a first position, and may swing to a second position by virtue of the mechanical coupling described above.

In some embodiments, support structure 102 may include a mechanism, such as winch 122, which may be configured to apply a rotational force to shaft 108 and pendulum 104 to position pendulum 104 in a first position, as shown in FIG. 1. Moreover, winch 122 may include a distance encoder configured to measure and identify a linear and/or rotational distance traveled by pendulum 104. In some embodiments, winch 122 may be included as a component of coupler 106. In various embodiments, operation of winch 122 may be controlled manually, or may be controlled by one or more components of a data processing system. As will be discussed in greater detail below, such a data processing system may be coupled with components of protective gear testing platform 100 via a communications interface which may be a wireless connection to one or more of the components, such as first headform 110, velocity gate 120, and target 116, or a wired connection coupled with an interface, such as interface 140 which may include internal wiring coupled to components, such as headform 110. In some embodiments, support structure 102 may also include a braking mechanism which may be configured to inhibit or stop pendulum 104 from moving or rotating. In some embodiments, such a braking mechanism may be configured to be engaged after headform 110 has impacted target 116, and after a testing protocol has been implemented.

As previously discussed, protective gear testing platform 100 may include pendulum 104 which may also be a rigid structure. Accordingly, pendulum 104 may also be made of a material such as metal, wood, or a polymer. In some embodiments, pendulum 104 may be made of the same material or a different material as support structure 102. In various embodiments, pendulum 104 may be coupled to another component of protective gear testing platform 100. For example, pendulum 104 may be coupled with headform 110 via first mounting plate 112. Accordingly, pendulum 104 may be configured to couple headform 110 with other components of protective gear testing platform 100, and may be further configured to swing headform 110 along a first pathway. In some embodiments, first mounting plate 112 may be configured to be adjustable in one or more directions. Accordingly, first mounting plate 112 may be configured such that an orientation and angle of headform 110 may be adjusted. In this way, first mounting plate 112 may be configured to provide six degrees of freedom to the positioning of headform 110. For example, first mounting plate 112 may include an adjustable ball head that enables rotation and movement of headform 110 along six degrees of freedom.

In various embodiments, headform 110 may be configured to approximate the shape of a human head. Accordingly, headform 110 may be made of a rigid material, such as a composite, polymer, or metal, and may be configured to have the shape of a human head. Moreover, headform 110 may be configured to be coupled with various components of protective gear. For example, protective gear, which may be a helmet, may be mounted on headform 110, and may be fastened to headform 110 using one or more fastening devices of the helmet. In this way, a helmet or other protective device may be coupled to headform 110 via fastening devices intended for use with portions of the human body, such as the head. Moreover, headform 110 may include various sensors, such as first sensors 130, configured to measure forces and accelerations experienced by headform 110. For example, headform 110 may include a 9-axis intertial motion sensor which may be configured to measure and generate measurement data characterizing motion and acceleration in three directions or axes as well as rotations about each axis. In some embodiments, such a sensor may include a 3-axis gyroscope, a 3-axis accelerometer, and a 3-axis magnetometer. In various embodiments, the sensor may further include angular sensors specifically configured to measure rotational forces. Accordingly, headform 110 may be configured to include various different configurations of sensors that are configured to generate measurement data, as discussed in greater detail below.

Protective gear testing platform 100 may further include base stage 114 which may be configured to position and provide structural support for target 116. Accordingly, as will be discussed in greater detail below, base stage 114 may be a movable stage mounted on rails, such as rails 124, and may be coupled with target 116 via second mounting plate 118. In some embodiments, base stage 114 may be configured to provide four degrees of motion to a component coupled to base stage 114, such as second mounting plate 118. For example, movement along rails 124 may move base plate 126 along a first direction, and may also move second mounting plate 118 and target 116 in the first direction. Moreover, coupling between second mounting plate 118 and base plate 126 may be adjustable such that second mounting plate 118 and target 116 can be moved laterally and along a second direction. Furthermore, as similarly discussed above, second mounting plate 118 may be configurable such that second mounting plate 118 may change a position and orientation of target 116. More specifically, second mounting plate 118 may be configured to provide six degrees of freedom to target 116.

In various embodiments, base stage 114 may further include velocity gate 120 which may be configured to measure a velocity of headform 110 as it swings along the first pathway. In some embodiments, velocity gate 120 may be configured to measure the velocity of headform 110 at a second position which may be a point along the first pathway that headform 110 impacts target 116. Accordingly, velocity gate 120 may be configured to measure a velocity of headform 110 at a time just before and/or during impact with target 116. Such measurements may be recorded as velocity data.

In various embodiments, target 116 may be another headform, such as a second headform. Accordingly, target 116 may also include sensors as described above, such as second sensors 132, may generate second measurement data, and may also be configured to be coupled to one or more protective devices. While FIG. 1 illustrates target 116 as including a headform, target 116 may be configured in various other ways as well. For example, target 116 may be configured to simulate one of a plurality of test surfaces. More specifically, target 116 may include a first test surface, which may be a synthetic turf as may be used on a football field. In this example, target 116 may include a square or rectangular substrate on which the first test surface is mounted. The first test surface may be positioned and oriented such that headform 110 impacts the first test surface when swung along the first pathway. Various other test surfaces may be implemented as well, such as concrete, asphalt, rubber, glass, and wood. Additional configurations of protective gear testing platform 100 are discussed in greater detail below.

As similarly discussed above, the configurability of the position and orientation of both headform 110 mounted on pendulum 104, as well as the position and orientation of target 116 may enable the testing of specific impact angles within particular impact scenarios, thus enabling the testing of variations of such angles on particular types of head trauma, such as shear injuries, rotational, and impact forces, as well as other factors such as oscillations on the helmet and headform. In one example, a specific scenario of a bicycle helmet impacting asphalt may be tested. Accordingly, a bicycle helmet may be coupled with headform 110, and target 116 may be configured to include a sample of asphalt. In various embodiments, the angle of headform 110 and the helmet relative to target 116 may be varied between numerous impact tests on target 116 to measure and analyze the effect of angle variances on the efficacy of the helmet when protecting against particular types of injuries, such as tissue shearing. Furthermore, the mounting of headform 110 on pendulum 104 which is swung at target 116 facilitates the accurate simulation of headform 110 and its associated protective device, such as a helmet, moving at a particular velocity and impacting a surface under such conditions.

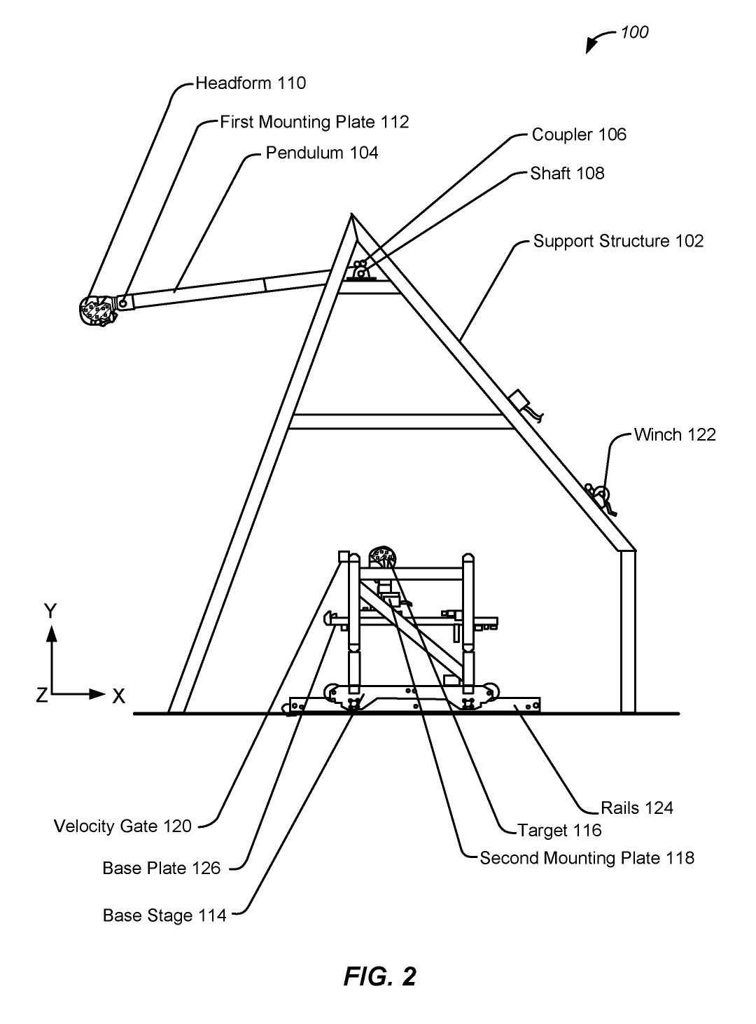

FIG. 2 illustrates another view of an example of a protective gear testing platform, configured in accordance with some embodiments. Accordingly, FIG. 2 further illustrates the orientation and relation of pendulum 104 and headform 110 to base stage 114 and target 116. As discussed above, a protective gear testing platform, such as protective gear testing platform 100, may include various components such as support structure 102 which may be coupled with pendulum 104 via coupler 106 and shaft 108. Moreover, pendulum 104 may be coupled with headform 110 via first mounting plate 112. Additionally, protective gear testing platform 100 may also include base stage 114 and base plate 126 which may be coupled with second mounting plate 118 and target 116. Also included may be velocity gate 120 and rails 124. As stated above, FIG. 2 further illustrates pendulum 104 positioned in the first position and ready to be released to swing along the first pathway to impact headform 110 with target 116. Also shown in FIG. 2 is a different configuration or location of winch 122, which may be located on a portion of support structure 102 and may be coupled with coupler 106 and shaft 108 via a line, rope, or cable.

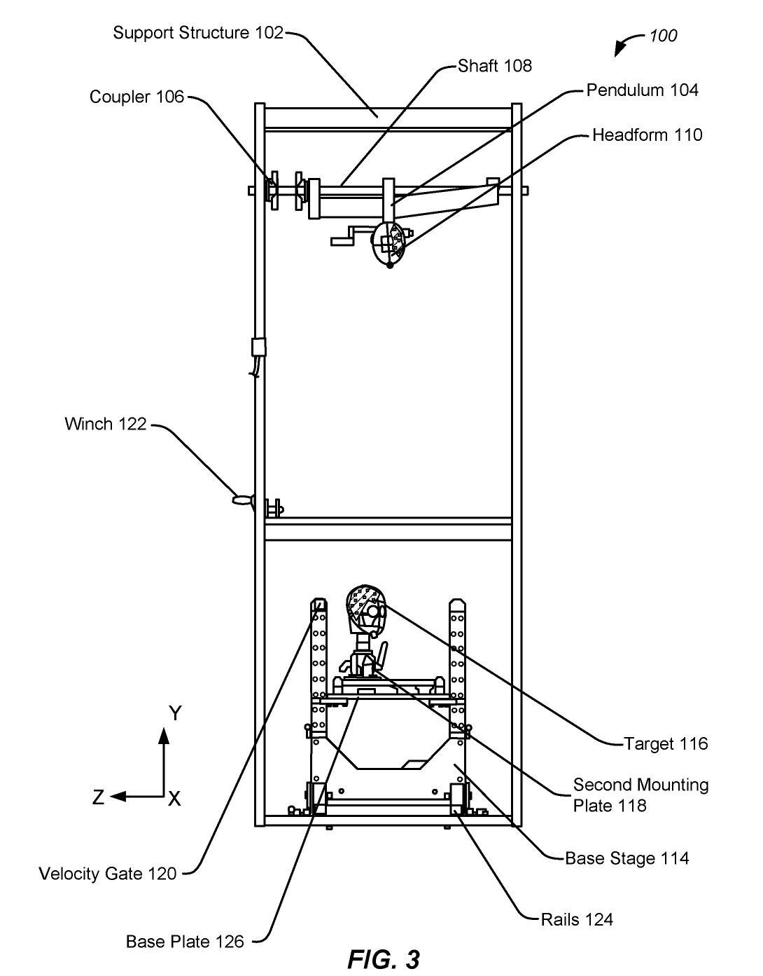

FIG. 3 illustrates yet another view of an example of a protective gear testing platform, configured in accordance with some embodiments. Accordingly, FIG. 3 further illustrates additional details of the orientation and relation of pendulum 104 and headform 110 to base stage 114 and target 116. As discussed above, a protective gear testing platform, such as protective gear testing platform 100, may include various components such as support structure 102 which may be coupled with pendulum 104 via coupler 106 and shaft 108. Additionally, protective gear testing platform 100 may also include base stage 114 and base plate 126 which may be coupled with second mounting plate 118 and target 116. Also included may be velocity gate 120, winch 122, and rails 124. As stated above, FIG. 3 further illustrates pendulum 104 positioned in the first position and ready to be released to swing along the first pathway to impact headform 110 with target 116. FIG. 3 further illustrates that headform 110 and target 116 may be positioned such that they are aligned, or off-center depending upon which type of impact is to be simulated. Accordingly, the position of target 116 may be moved by changing a position of second mounting plate 118 relative to base plate 126, and target 116 may be aligned with headform 110 or may be positioned such that it is off-center relative to headform 110, as shown in FIG. 3.

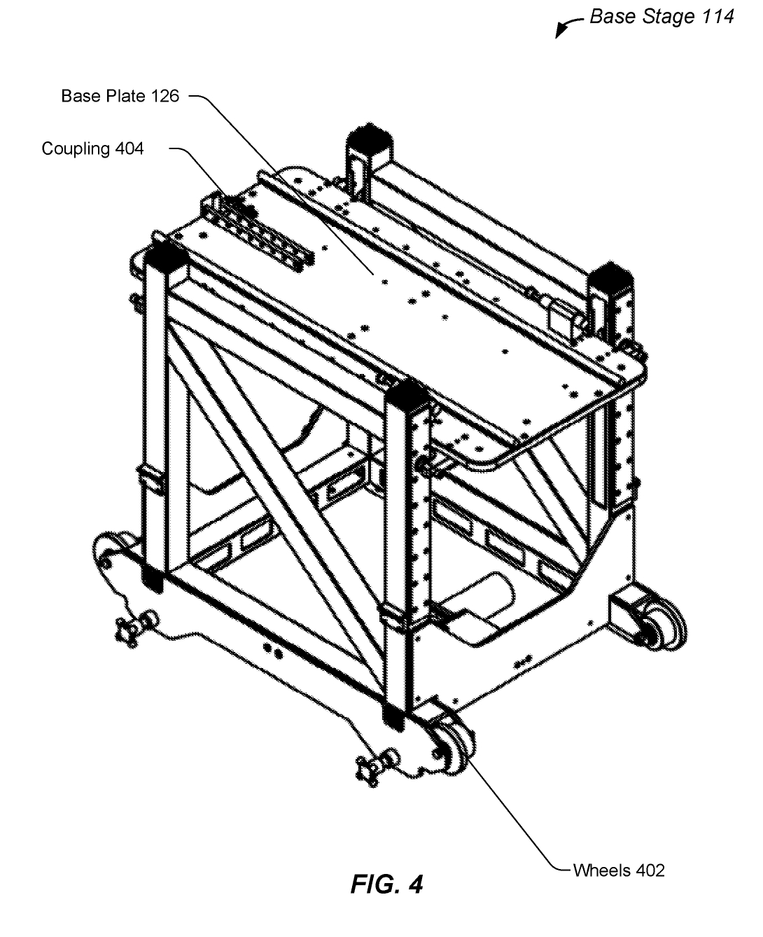

FIG. 4 illustrates a base stage associated with a protective gear testing platform, configured in accordance with some embodiments. As discussed above, a base stage, such as base stage 114, may be configured to position a target, such as target 116, within a pathway along which a headform, such as headform 110, is swung. As also stated above, base stage 114 may be movable along rails, such as rails 124, which may be coupled with base stage 114 via a movable coupling, such as wheels 402. Moreover, base stage 114 may include a base plate, such as base plate 126, which may be configured to provide a surface on which a mounting plate, such as second mounting plate 118, may be mounted, and such a mounting plate may be coupled with a target. As shown in FIG. 4, base plate 126 may include a coupling, such as coupling 404, which may be adjustable and configurable to facilitate the movement and adjustment of second mounting plate 118 and target 116 relative to base stage 114 and support structure 102. For example, coupling 404 may include numerous mounting holes that enable second mounting plate 118 to be coupled at numerous different positions along a length of base stage 114. Moreover, base plate 126 may include various mounting holes that enable coupling 404 to be moved and mounted at numerous different positions along a length and width of base plate 126. In this way, a position of coupling 404 relative to base plate 126, as well as a location of coupling between coupling 404 and second mounting plate 118 may be configured and adjusted to adjust and change a position of target 116.

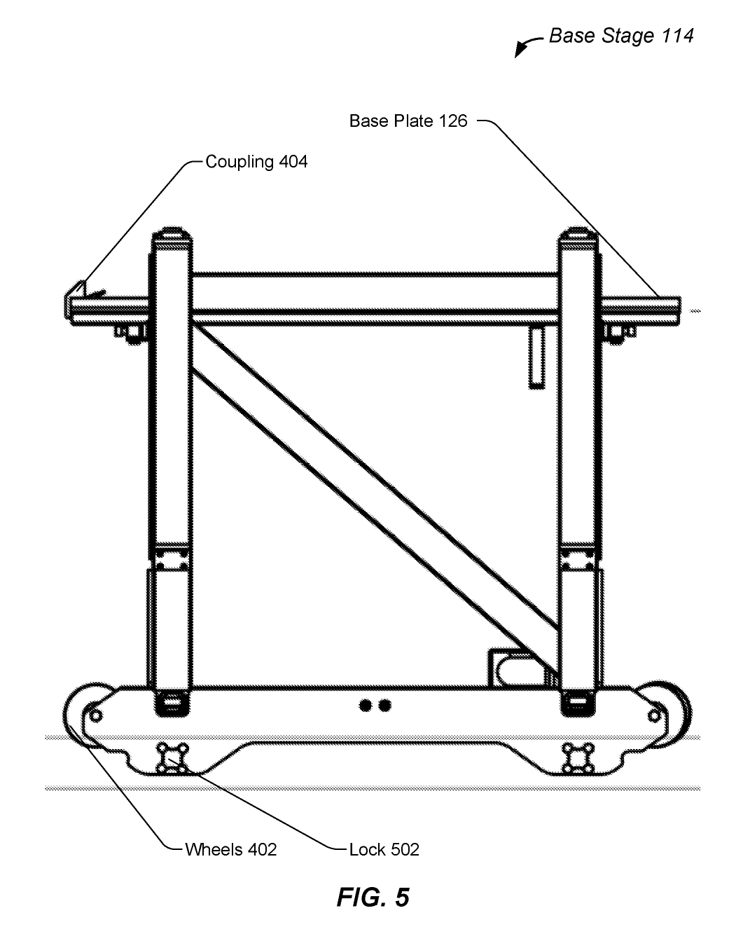

FIG. 5 illustrates another view of a base stage associated with a protective gear testing platform, configured in accordance with some embodiments. As discussed above, a base stage, such as base stage 114, may be configured to position a target, such as target 116, within a pathway along which a headform, such as headform 110, is swung. As also stated above, base stage 114 may include wheels 402, base plate 126, and coupling 404. As further shown in FIG. 5, base stage 114 may include various locking mechanisms such as lock 502. In various embodiments, lock 502 may be configured to fasten or secure one or more of the wheels of base stage 114, such as wheel 402. Accordingly, when engaged, lock 502 may secure wheel 402 and prevent rotation of wheel 402, and may further prevent movement of base stage 114 along rails 124. In various embodiments, base stage 114 may include numerous locking mechanisms. For example, base stage 114 may include four locks, where one lock is provided for each wheel.

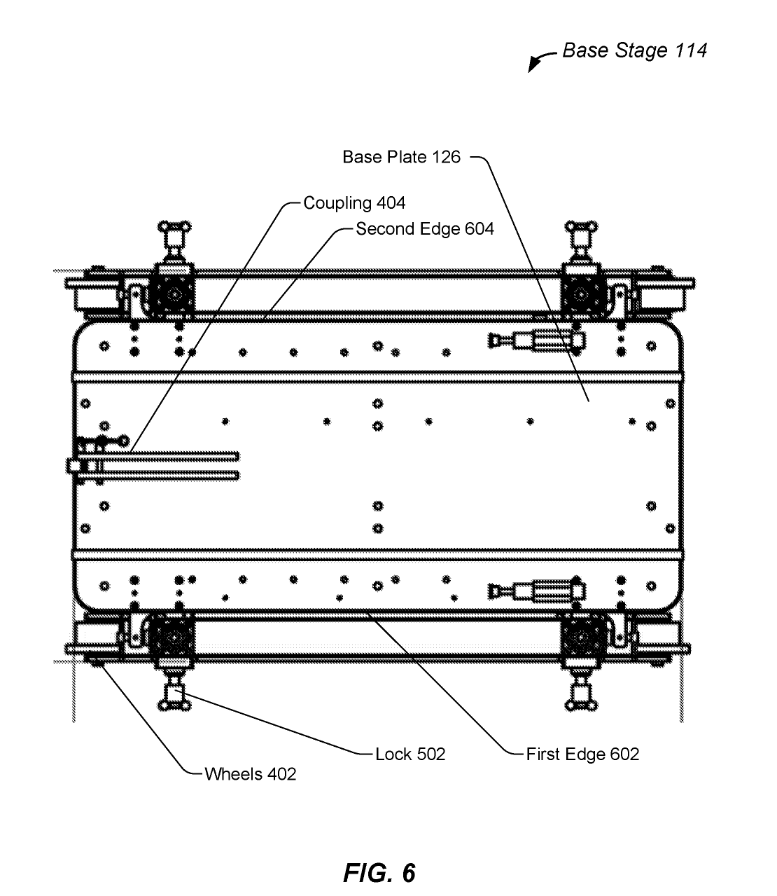

FIG. 6 illustrates another view of a base stage associated with a protective gear testing platform, configured in accordance with some embodiments. As similarly discussed above, a base stage, such as base stage 114, may be configured to position a target, such as target 116, within a pathway along which a headform, such as headform 110, is swung. As also stated above, base stage 114 may include wheels 402, base plate 126, and coupling 404. As further shown in FIG. 6, base plate 126 may be coupled with coupling 404 along a centerline of base plate 126. In this example, coupling 404 is positioned such that second mounting plate 118 and target 116 are positioned directly in the first pathway, and is centrally aligned with the first pathway. When target 116 is centrally aligned in such a way, and when headform 110 is centrally aligned as well, an impact may be simulated where there the lateral or horizontal offset between target 116 and headform 110 is reduced, and the impact is a direct impact. As discussed above, the position of coupling 404 may be modified and configured to offset the alignment of second mounting plate 118 and target 116. For example, coupling 404 may be moved closer to first edge 602, or may be moved closer to second edge 604.

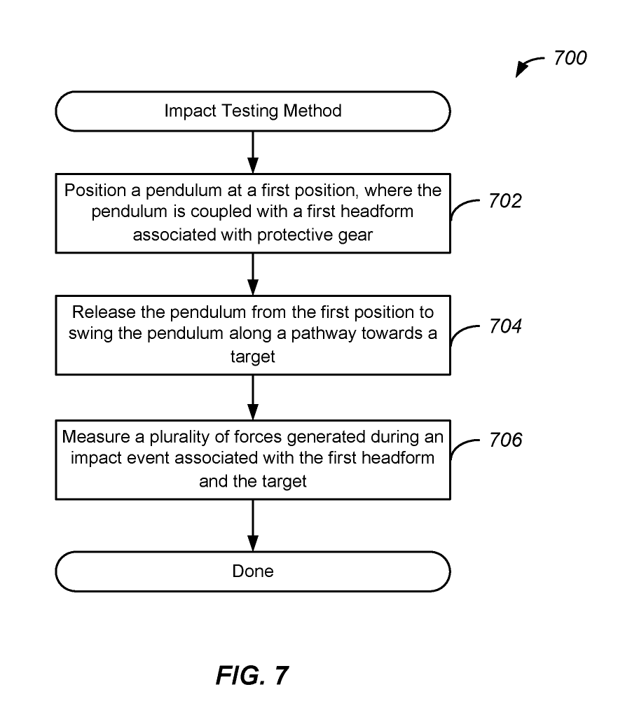

FIG. 7 illustrates a flow chart of an example of an impact testing method, implemented in accordance with some embodiments. As will be discussed in greater detail below, a method, such as method 700, may be implemented to test and assess the efficacy of protective gear when protecting against impact events. Accordingly, method 700 may enable a manufacturer or other entity to test impact events generated using various different configurations of protective gear, targets, and impact angles/offsets between the two. Moreover, method 700 may further enable the manufacturer or other entity to determine how effective the protective gear is during such impact events.

Method 700 may commence with operation 702 during which a pendulum may be positioned at a first position. As discussed above, the pendulum may be coupled to a support structure via a first coupling, and the pendulum may be further coupled to a first headform that includes a plurality of sensors. As also discussed above, the first headform may be coupled with various protective gear, such as a helmet, that may be configured to reduce the forces experienced by the first headform during impact events. Accordingly, during operation 702, the pendulum, as well as a first headform and protective gear, may be moved to a first position having a first amount of potential energy.

Method 700 may proceed to operation 704 during which the pendulum may be released from the first position. In some embodiments, the releasing causes the pendulum to swing along a pathway in a first direction and towards a target coupled to a base stage. Accordingly, the stored potential energy may become kinetic energy as the pendulum, first headform, and protective gear is swung at the target. As will be discussed in greater detail below, the first headform and protective gear may swing along a pathway until impacting the target.

Method 700 may proceed to operation 706 during which a plurality of forces may be measured. In various embodiments, the forces may be experienced by the first headform, and the forces may be generated by the occurrence of an impact event associated with the target. As will be discussed in greater detail below, the forces may be measured by the sensors included in the headform, and provided to a data processing system as measurement data. The measurement data may be maintained and processed locally or maintained and processed using cloud resources. The impact event may occur when the first headform collides with the target when positioned in the pathway. Accordingly, the first headform may be swung along the pathway, may collide with the target, and various measurements may be made where such measurements characterize the forces generated by the impact, and further characterize, at least in part, the efficacy of the protective gear coupled with the first headform.

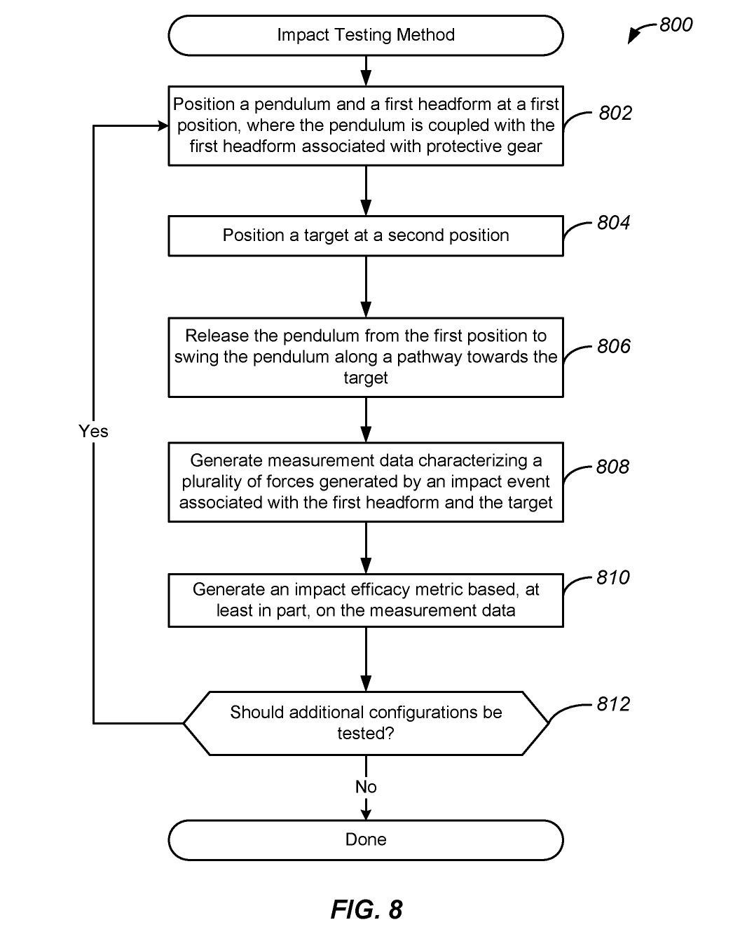

FIG. 8 illustrates a flow chart of another example of an impact testing method, implemented in accordance with some embodiments. As similarly discussed above, a method, such as method 800, may be implemented to test and assess the efficacy of protective gear when protecting against impact events. As will be discussed in greater detail below, method 800 may enable a manufacturer or other entity to configure various aspects of headforms and targets used during such tests such that a variety of different impact scenarios may be simulated. Accordingly, positions of the headforms and targets may be adjusted to implement offsets between the two. Moreover, various different types of targets may be used to simulate impacts of the headform and associated protective gear with numerous different types of objects. In this way, method 800 may be implemented to test protective gear under a variety of different scenarios, and during a variety of different types of impact events.

Method 800 may commence with operation 802 during which a pendulum may be positioned at a first position. Furthermore, the pendulum may be coupled with a first headform that may be coupled with protective gear such as a helmet. The pendulum may be positioned at a first position and held in place by a locking mechanism that may be included in a coupler, such as coupler 106. When positioned in the first position, the pendulum may have an amount of potential energy created, at least in part, by gravity. As will be discussed in greater detail below, when released from the first position, the potential energy may be converted to kinetic energy, and the pendulum may swing along a pathway. In various embodiments, movement of the pendulum to the first position may be controlled by a mechanical component, such as a winch. Moreover, the winch may include a rotational or linear encoder configured to identify a distance (linear or angular) traveled from a resting position, which may be a vertical position relative to support structure 102 that has a potential energy of about zero. Accordingly, a distance may be identified based on an input provided by a user or a test protocol, and the winch may be engaged to move the pendulum until the encoder identifies that the pendulum has been moved to the designated distance. In this way, the first position may be configurable and may be determined based on the designated distance.

During operation 802, the first headform may also be positioned at an initial or first position. As discussed above, the position of the first headform may be configurable based on rotation and adjustments made to a first mounting plate. Accordingly, the position and mounting of the first headform may be adjusted by rotating one or more axes of the first mounting plate coupling the first headform with the pendulum. In this way, the first headform may be positioned and oriented such that it is directly facing the target, or may be angled, at least to some degree along any of the X, Y, and/or Z axes and XY, XZ, and YZ planes, away from the target. Accordingly, any suitable adjustment may be made to the position of the first headform relative to the target so simulate numerous different types of impacts, such as a head-on direct impact, as well as a side impact.

Method 800 may proceed to operation 804 during which a target may be positioned at a second position. As discussed above, a base stage, base plate, as well as a second mounting plate may be moved and adjusted to set an orientation and position of a target. Accordingly, the target may be positioned at a second position that may be configured to simulate a particular type of impact with the first headform. For example, the target may be positioned in the pathway of the pendulum and first headform, and may be aligned with a centerline of the first headform to simulate a direct impact. In another example, the target may be rotated to simulate an impact that occurs at an angle relative to the headform. In yet another example, the target may be offset from a centerline of the headform to simulate an off-center impact. As discussed above and shown in at least FIG. 1, such angles and offsets may be implemented along any of the X, Y, and/or Z axes and XY, XZ, and/or YZ planes.

As discussed above, the target may be one of many different types of targets. For example, the target may be a second headform that includes additional sensors. In another example, the target may be a sample of a surface, such as an amount of area of a synthetic turf In this way, the target may be configured to simulate any number of objects and surfaces with which protective gear may collide. According to various embodiments, it is beneficial to mount a headform on a pendulum so that forces from impact with a variety of different objects and environments can be simulated. For example, a football helmet to turf impact can be tested by strapping a football helmet onto the headform and using a piece of turf as the target. Similarly, bike helmet to asphalt impact can be tested by strapping a bike helmet onto the headform and using a piece of asphalt as the target. The helmet and headform on the pendulum can strike the piece of turf or the piece of asphalt at a variety of different incident angles to allow measurement of both the resultant shear, rotational, and impact forces as well as oscillations on the helmet and headform. In still other embodiments, a headform with a helmet on a pendulum is used to strike a headform with a helmet mounted on the base.

Method 800 may proceed to operation 806 during which the pendulum may be released from the first position. When released, the pendulum may swing along a pathway towards the target. As discussed above, the locking mechanism included in the coupler, such as coupler 106, may be disengaged, and the pendulum may be released. Gravity may facilitate the conversion of potential energy to kinetic energy, and the pendulum may swing along a pathway towards the target. In various embodiments, the first headform may impact the target by colliding with the target and enduring an impact event. As discussed above, a braking device may be used to stop the movement of the pendulum after the occurrence of the impact event.

Method 800 may proceed to operation 808 during which measurement data may be generated. In various embodiments, the measurement data may characterize forces generated by an impact event that occurs when the first headform collides with and impacts the target. In various embodiments, the measurement data may also include a velocity measurement made by a velocity gate at a moment just prior to the impact event. Such a velocity measurement may be used to identify the velocity of the first headform at the time of impact. As discussed above, sensors and sensing circuitry included in the first headform may acquire force measurements from the sensors over a period of time to generate a time course identifying force measurements over time. The sensors may be started at a particular time, such as during operation 802, and may be stopped at a time after the impact event. As discussed above, the sensors may be configured to measure different types of forces, such as linear and rotational forces, in various different axes. In this way, the sensors may generate measurement data that includes several time courses of force measurements from the various sensors. As also discussed above, the target may be a second headform that also includes sensors configured to acquire force measurements. Accordingly, the measurement data may include measurements from sensors of the first headform as well as measurements from sensors of the second headform.

Once acquired, the measurement data may be transferred to a data processing system. In various embodiments, the data may be manually transferred. For example, the measurement data may be stored on a memory device also included in the sensing circuitry included in the first headform and, in some embodiments, the second headform. The memory devices may be removable memory devices, such as memory cards, that may be removed from the first and second headforms, and communicatively coupled with the data processing system. In various embodiments, the measurement data may be transferred to the data processing system via a communications interface. Accordingly, the communications interface may be a wired connection, such as an Ethernet port, or a wireless connection, such as a wifi connection or a Bluetooth connection. In this way, the measurement data may be transferred to the data processing system via a network, which may be a local network or the internet.

Method 800 may proceed to operation 810 during which an impact efficacy metric may be generated based on the measurement data. Accordingly, the data processing system may generate one or more metrics based on the measurement data, and such metrics may characterize an efficacy of the protective gear in reducing the effect of the impact event on the first headform. In some embodiments, the efficacy metric may be generated based on a comparison of one or more measurements within the measurement data with various thresholds. For example, the data processing system may compare the amplitudes of the forces included in the time courses with a designated threshold that may represent a limit of permissible force applied to a human brain. The data processing system may generate an impact efficacy metric based on the result of the comparison. For example, if the measured forces are below the threshold, the impact efficacy metric may identify a “pass”. If the measured forces are above the threshold, the impact efficacy metric may identify a “fail”. Moreover, combinations of different measurements from different sensors may also be analyzed and compared with several thresholds. Accordingly, combinations of different force measurements along different axes may be used to identify a single impact efficacy metric. In this way, an impact efficacy metric may be generated based on a combination of measurements and threshold crossings.

In some embodiments, the impact efficacy metric may characterize a particular type of brain injury and a severity of the injury. In various embodiments, the data processing system may include a file or database that includes a mapping of measurements or conditions to particular types of brain injuries. Accordingly, one or more measurements or conditions, such as threshold crossings, may be identified and may be used to query the database. In this example, the measurements or conditions are used as a key to query the database system. In a specific example, the conditions may identify a threshold crossing along a first axis, as well as a threshold crossing along a second axis. If a match is found in the database, the entry associated with the matching key may be returned as a result. In one example, such a result may be a particular type of trauma such as “concussion”. In some embodiments, a severity of the type of brain injury may be determined based on an amount by which the thresholds were crossed. For example, if the thresholds were crossed by an average of 20% amplitude, the severity of the injury may be characterized as “severe”.

In various embodiments, impact efficacy metric may be included with various other parameters in an impact evaluation report. Such other parameters may characterize and identify the settings used for the impact test. Such settings may identify the distance setting used for the positioning of the first pendulum, the type of target used, as well as any other suitable configuration parameters. In this way, a report may be generated that provides the impact efficacy metric as well as contextual data associated with the impact efficacy metric.

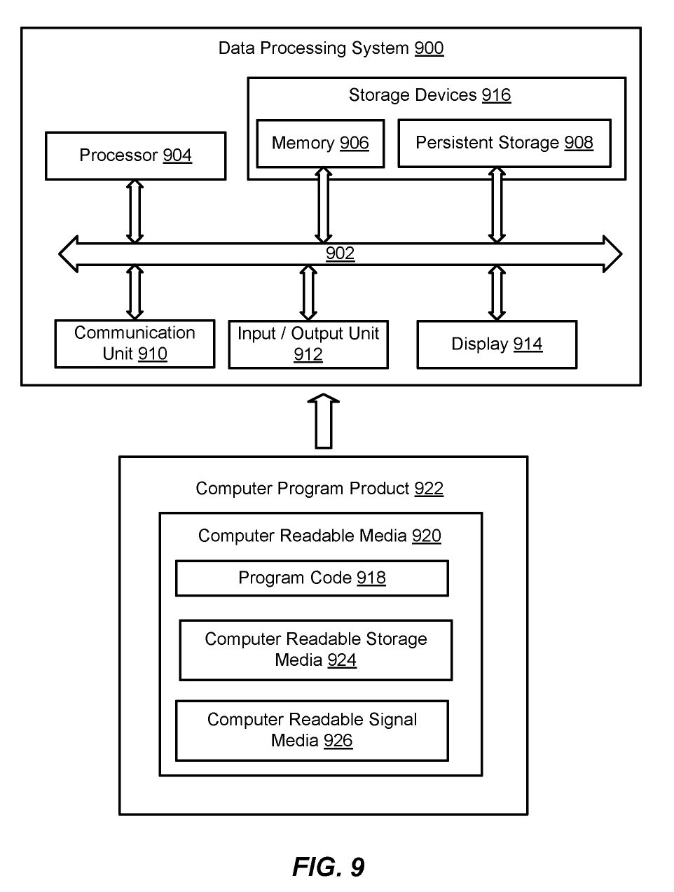

Method 800 may proceed to operation 812 during which it may be determined whether additional configurations should be tested. Such a determination may be made by a user or based on a designated parameter of a test program or protocol executed by a data processing system, as described in greater detail below with reference to FIG. 9. For example, it may be determined that additional types of targets should be tested, or different angles and orientations of a target should be tested. More specifically, a test protocol may be implemented where a target is rotated in a particular direction in designated angular increments for a designated number of iterations of method 800. If it is determined that additional configurations should be tested, method 800 may return to operation 802. If it is determined that additional configurations should not be tested, method 800 may terminate.

FIG. 9 illustrates a data processing system configured in accordance with some embodiments. The data processing system 900, also referred to herein as a computer system, may be used to implement one or more computers or processing devices used to control various components of devices and systems described above, as may occur during the implementation of testing operations. In some embodiments, the data processing system 900 includes a communications framework 902, which provides communications between a processor unit 904, a memory 906, a persistent storage 908, a communications unit 910, an input/output (I/O) unit 912, and a display 914. In this example, the communications framework 902 may take the form of a bus system.

A processor unit 904 serves to execute instructions for software that may be loaded into the memory 906. The processor unit 904 may be a number of processors, as may be included in a multi-processor core. In various embodiments, the processor unit 904 is specifically configured and optimized to process large amounts of data that may be involved when processing measurement data, as discussed above. Thus, the processor unit 904 may be an application specific processor that may be implemented as one or more application specific integrated circuits (ASICs) within a processing system. Such specific configuration of the processor unit 904 may provide increased efficiency when processing the large amounts of data involved with the previously described systems, devices, and methods. Moreover, in some embodiments, the processor unit 904 may be include one or more reprogrammable logic devices, such as field-programmable gate arrays (FPGAs), that may be programmed or specifically configured to optimally perform the previously described processing operations in the context of large and complex data sets.

The memory 906 and the persistent storage 908 are examples of storage devices 916. A storage device is any piece of hardware that is capable of storing information, such as, for example, without limitation, data, program code in functional form, and/or other suitable information either on a temporary basis and/or a permanent basis. The storage devices 916 may also be referred to as computer readable storage devices in these illustrative examples. The memory 906, in these examples, may be, for example, a random access memory or any other suitable volatile or non-volatile storage device. The persistent storage 908 may take various forms, depending on the particular implementation. For example, the persistent storage 908 may contain one or more components or devices. For example, the persistent storage 908 may be a hard drive, a flash memory, a rewritable optical disk, a rewritable magnetic tape, or some combination of the above. The media used by the persistent storage 908 also may be removable. For example, a removable hard drive may be used for the persistent storage 908.

The communications unit 910, in these illustrative examples, provides for communications with other data processing systems or devices. In these illustrative examples, the communications unit 910 is a network interface card.

The input/output unit 912 allows for input and output of data with other devices that may be connected to the data processing system 900. For example, the input/output unit 912 may provide a connection for user input through a keyboard, a mouse, and/or some other suitable input device. Further, the input/output unit 912 may send output to a printer. The display 914 provides a mechanism to display information to a user.

Instructions for the operating system, applications, and/or programs may be located in the storage devices 916, which are in communication with the processor unit 904 through the communications framework 902. The processes of the different embodiments may be performed by the processor unit 904 using computer-implemented instructions, which may be located in a memory, such as the memory 906.

These instructions are referred to as program code, computer usable program code, or computer readable program code that may be read and executed by a processor in the processor unit 904. The program code in the different embodiments may be embodied on different physical or computer readable storage media, such as the memory 906 or the persistent storage 908.

The program code 918 is located in a functional form on a computer readable media 920 that is selectively removable and may be loaded onto or transferred to the data processing system 900 for execution by the processor unit 904. The program code 918 and the computer readable media 920 form the computer program product 922 in these illustrative examples. In one example, the computer readable media 920 may be a computer readable storage media 924 or a computer readable signal media 926.

In these illustrative examples, the computer readable storage media 924 is a physical or tangible storage device used to store the program code 918 rather than a medium that propagates or transmits the program code 918.

Alternatively, the program code 918 may be transferred to the data processing system 900 using the computer readable signal media 926. The computer readable signal media 926 may be, for example, a propagated data signal containing the program code 918. For example, the computer readable signal media 926 may be an electromagnetic signal, an optical signal, and/or any other suitable type of signal. These signals may be transmitted over communications links, such as wireless communications links, optical fiber cable, coaxial cable, a wire, and/or any other suitable type of communications link.

The different components illustrated for the data processing system 900 are not meant to provide architectural limitations to the manner in which different embodiments may be implemented. The different illustrative embodiments may be implemented in a data processing system including components in addition to and/or in place of those illustrated for the data processing system 900. Other components shown in FIG. 9 can be varied from the illustrative examples shown. The different embodiments may be implemented using any hardware device or system capable of running the program code 918.

Although the foregoing concepts have been described in some detail for purposes of clarity of understanding, it will be apparent that certain changes and modifications may be practiced within the scope of the appended claims. It should be noted that there are many alternative ways of implementing the processes, systems, and devices. Accordingly, the present examples are to be considered as illustrative and not restrictive.

What is claimed is:

1. A system comprising:
a support structure;
a pendulum coupled to the support structure via a first coupling, the pendulum being configured to be positioned at a first position, and further configured to swing along a pathway in a first direction when released from the first position;
a first headform coupled with the pendulum, the first headform including a plurality of sensors configured to measure a plurality of forces associated with an impact on the first headform, the plurality of forces including impact and rotational forces;
a base stage configured to be coupled with a target, and further configured to position the target within the pathway; and
a communication interface coupled to a plurality of sensors included in the first headform, the communication interface configured to transfer measurement data from the system to a network.

2. The system of claim 1, wherein the first headform comprises a plurality of sensors configured to measure the plurality of forces experienced by the first headform, and further configured to generate measurement data characterizing the plurality of forces, wherein the measurement data is maintained and processed using a plurality of cloud resources.

3. The system of claim 1, wherein the first headform is configured to be coupled with a helmet such that the helmet is mounted on the first headform to protect the first headform.

4. The system of claim 1 further comprising:
a first mounting plate configured to couple the first headform with the pendulum, the first mounting plate being configured to adjustably position the first headform such that an orientation of the first headform is adjustable.

5. The system of claim 1 further comprising:
a second mounting plate configured to couple the target with the base stage, the second mounting plate being configured to adjustably position the target such that an orientation of the target is adjustable.

6. The system of claim 1, wherein the target is a second headform.

7. The system of claim 1, wherein the base stage is configured to be movable in a plurality of directions.

8. The system of claim 1 further comprising:
a velocity gate configured to measure a velocity of the first headform when swinging along the pathway.

9. The system of claim 1 further comprising:
a braking device configured to reduce movement of the pendulum after an impact event has occurred.

10. The system of claim 1 further comprising:
a winch configured to move the pendulum to the first position.

11. A device comprising:
a support structure;
a pendulum coupled to the support structure via a first coupling, the pendulum being configured to be positioned at a first position, and further configured to swing along a pathway in a first direction when released from the first position; and
a first headform coupled with the pendulum, the first headform including a plurality of sensors configured to measure a plurality of forces associated with an impact between the first headform and a target coupled with a base stage, the plurality of forces including impact and rotational forces.

12. The device of claim 11, wherein the first headform comprises a plurality of sensors configured to measure the plurality of forces experienced by the first headform, and further configured to generate measurement data characterizing the plurality of forces, and wherein the first headform is configured to be coupled with a helmet such that the helmet is mounted on the first headform to protect the first headform.

13. The device of claim 11, wherein the device further comprises:
a first mounting plate configured to couple the first headform with the pendulum, the first mounting plate being configured to adjustably position the first headform such that an orientation of the first headform is adjustable.

14. The device of claim 11, wherein the base stage is configured to position the target within the pathway, and wherein the base stage is configured to be movable in a plurality of directions.

15. The device of claim 11, wherein the target is a second headform.

16. A method comprising:
positioning a pendulum at a first position, the pendulum being coupled to a support structure via a first coupling, and the pendulum being further coupled to a first headform comprising a plurality of sensors;
releasing the pendulum from the first position, the releasing causing the pendulum to swing along a pathway in a first direction and towards a target coupled to a base stage;
measuring, using the plurality of sensors, a plurality of forces experienced by the first headform, the plurality of forces including an impact event associated with the target; and
distributing measurement data from the plurality of sensors to a plurality of network resources.

17. The method of claim 16 further comprising:
coupling, before the positioning, a helmet to the first headform.

18. The method of claim 16 further comprising:
stopping, using a braking device, a movement of the pendulum after the impact event.

19. The method of claim 16 further comprising:
measuring, using a velocity gate, a velocity of the first headform while swinging along the pathway and during the impact event.

20. The method of claim 16, wherein the pendulum is positioned at the first position via a winch.
